(19) United States
(12) Patent Application Publication
(10) Pub. No.: US 2013/0262179 A1
(43) Pub. Date: Oct. 3, 2013

(54) INFORMATION TERMINAL FOR ANALYZING SALES AND RELATED METHODS

(71) Applicant: TOSHIBA TEC KABUSHIKI KAISHA, Tokyo (JP)

(72) Inventor: Yukio HARADA, Kanagawa (JP)

(73) Assignee: Toshiba Tec Kabushiki Kaisha, Tokyo (JP)

(21) Appl. No.: 13/777,932

(22) Filed: Feb. 26, 2013

(30) Foreign Application Priority Data
Mar. 30, 2012 (JP) 2012-082116

(51) Int. Cl. G06Q 30/02

(52) U.S. Cl. CPC G06Q 30/0201
USPC 705/7.29

(57) ABSTRACT

An information terminal includes an acquisition unit configured to calculate the number of people who stop at a counter where a product is displayed over a time period, and acquire sales data of the product over the time period. The information terminal further comprises a display unit configured to display the number of people who stop at the counter over the time period and the sales data of the product over the time period.

### CROSS-REFERENCE TO RELATED APPLICATION

This application is based upon and claims the benefit of priority from Japanese Patent Application No. 2012-082116, filed Mar. 30, 2012; the entire contents of which are incorporated herein by reference.

### FIELD

Embodiments described herein are related generally to an information terminal and program.

### BACKGROUND

Previously, in supermarkets, convenience stores etc., a POS (Point Of Sale) terminal is established to count the number of sales of products over a time period in order to find out which products are being sold and which are not.

However, this type of terminal does not provide information that can be used to analyze the reason why products are not selling.

### DESCRIPTION OF THE DRAWINGS

FIG. 1 is a general diagram illustrating components of a POS system according to an embodiment.

FIG. 2 is a perspective view of an information terminal, as seen from the front side, according to an embodiment.

FIG. 3 is a perspective view of the information terminal, as seen from the rear side, according to an embodiment.

FIG. 4 is a block diagram showing components of the information terminal according to the embodiment.

FIG. 5 is a block diagram showing components of a store computer according to the embodiment.

FIG. 6 is an example of data items that make up a product master table according to the embodiment.

FIG. 7 is an example of data items that make up store sales table according to the embodiment.

FIG. 8 is an example of image files that constitute store video data according to the embodiment.

FIG. 9 is an example of data items that constitute analysis data according to the embodiment.

FIG. 10 is a functional block diagram of a store management process of the information terminal according to the embodiment.

FIG. 11 is a flowchart showing an example of an operation of the information terminal according to the embodiment.

FIG. 12 is an example of a display screen according to the embodiment.

FIG. 13 is another example of the display screen according to the embodiment.

FIG. 14 is another example of the display screen according to the embodiment.

### DETAILED DESCRIPTION

An information terminal is disclosed. The information terminal comprises an acquisition unit configured to calculate the number of people who stop at a counter where a product is displayed over a time period, and acquire sales data of the product over the time period. The information terminal further comprises a display unit configured to display the number of people who stop at the counter over the time period and the sales data of the product over the time period.

A method of analyzing sales is disclosed. The method comprises calculating a number of people who stop at a counter where a product is displayed over a time period and acquiring sales data of the product over the time period. The method further comprises displaying the number of people who stop at the counter over the time period and the sales data of the product over the time period.

A non-transitory computer-readable storage medium that stores a computer program is disclosed. The computer program causes a computer to perform the steps of calculating the number of people who stop at a counter where a product is displayed over a time period, acquiring sales data of the product over the time period, and displaying the number of people who stop at the counter over the time period and the sales data of the product over the time period.

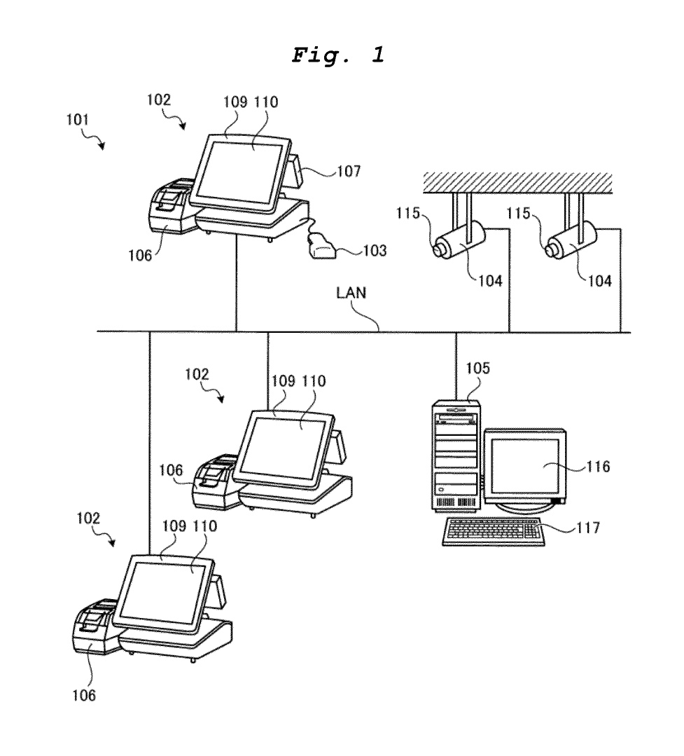

FIG. 1 is a general diagram illustrating components of a POS system 101. The POS system 101 includes information terminals 102 installed in register units or store office area, live cameras 104, and a store computer 105 that is a server controlling the total POS system 101 and is installed in the store office area. Also, in the POS system 101, the information terminal 102, the live camera 104, and the store computer 105 are connected with a communication network such as LAN (Local Area Network).

At least one information terminal 102 is a POS terminal installed in the register unit or an information device. Another information terminal 102 is installed in the store office and is used for executing store management processes such as monitoring product inventory and sales.

The information terminal 102 may be installed in a register unit or in the store office, but its basic structure and functions are the same. The difference is in its mode of use.

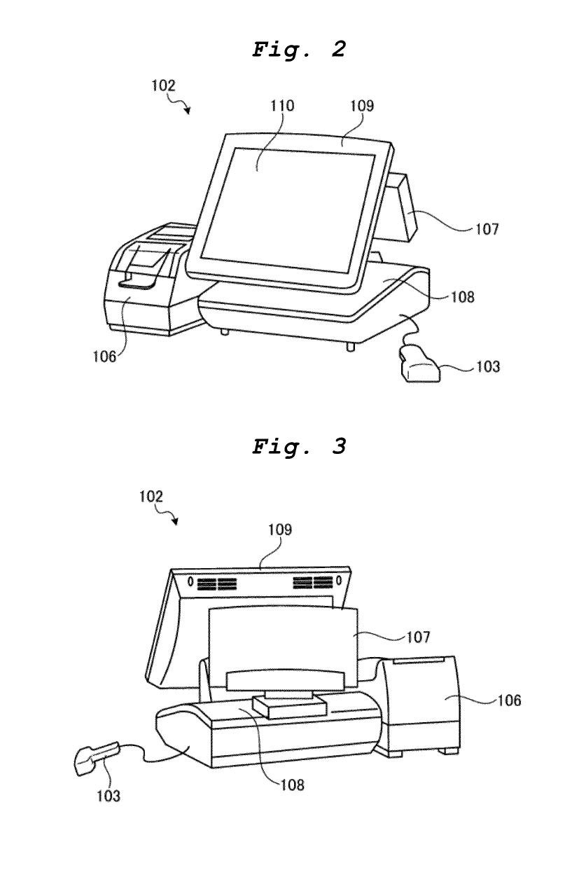

The information terminal 102 that is installed in the register unit functions as a POS terminal and carries out the sales processing including the accounting and registration of the sales product, in addition to the sales counter management processes like checking the product inventory and sales of products. As can be seen if FIG. 2, the information terminal 102 installed in the register unit includes a printer 106 for printing a receipt or information related to stock and sales of the product, a display 109 (such as an LCD) for display of various information, and a touch panel 110 for input from user. Display 109 is an example of an output device. Additionally, the information terminal 102 installed in register unit as a POS terminal includes a scanner device 103 Fig. that optically reads a barcode or 2-dimensional code attached to the product sold in the store. The information terminal 102 also has a customer-side display device 107 (refer to FIG. 2) for displaying the accounting details tabulated by the register unit to the customer.

FIG. 2 is a perspective view of the information terminal 102 functioning as a POS terminal, as seen from the front side. The information terminal 102 includes the display 109, which acts as a display device and is placed on top surface of a main unit 108. The display 109 includes a display panel 110 laminated on top of the display surface. The display panel 110 accepts touch input, so that display 109 is operable as a touchscreen input device. Printer 106 is installed in the vicinity of information terminal 102. The printer 106 and scanner 103 are connected to the information terminal 102 via an interface such as USB (Universal Serial Bus).

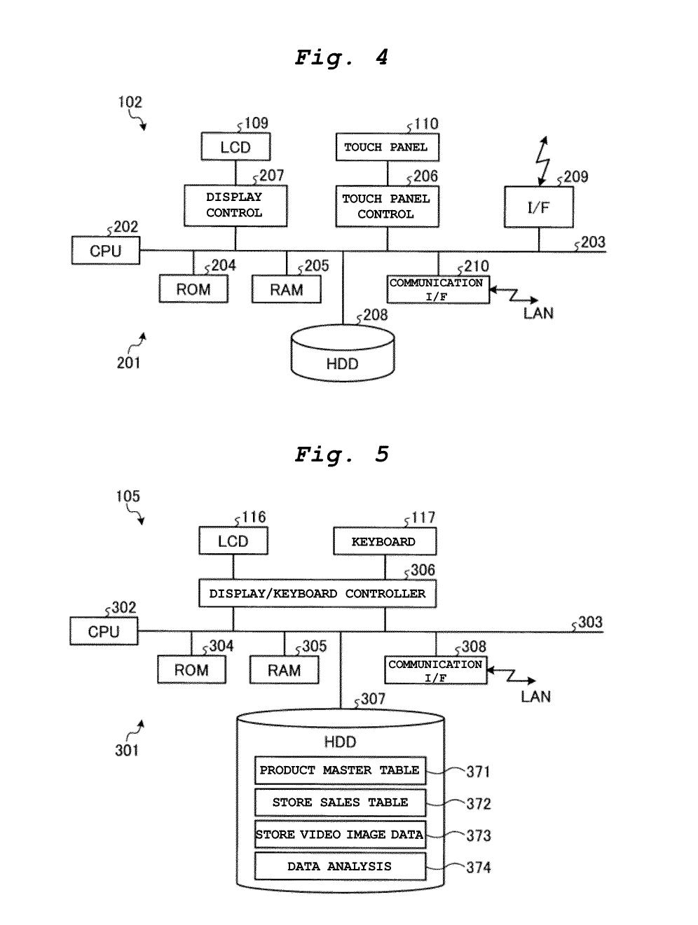

FIG. 3 is a perspective view of the information terminal 102 functioning as a POS terminal, as seen from the rear side. FIG. 3 clearly displays the customer side display device 107. An LED (Light Emitting Diode) display device with a 7-segment display is an example of the customer-side display device 107. The customer-side display device 107 is installed on the top surface of the main unit 108 of information terminal 102. Similar to the printer 106 and scanner 103, the customer-side display device 107 is connected to the information terminal 102 via a USB interface.

Returning to FIG. 1, the live camera 104 records the image captured by a lens 115 on a 2-dimensional CCD array (not shown). The live camera 104 converts the output of the 2-dimensional CCD array into a moving image by amplification, A/D conversion, filtering, etc.

A live camera 104 is an example of an imaging device for monitoring the sales counter. The live camera 104 is installed at each sales counter within the store and transmits in detail the image of display shelves, etc., as a video image. The delicatessen counter, meat counter, fish counter, daily delivery counter, etc. are examples of sales counters. Furthermore, each live camera 104 installed at each sales counter has a unique network address in the LAN (for example, IP address, MAC address, etc.). As a result, the information terminal 102 and store computer 105 can obtain the video transmitted from the live camera 104 of a specific sales counter by specifying the network address.

Store computer 105 includes a liquid crystal display 116 and keyboard 117. The store computer 105 stores and manages the information transmitted from information terminal 102. The store computer 105 also manages the video of each sales counter that is transmitted by the live camera 104.

FIG. 4 is a block diagram showing the components of the information terminal 102. As shown in FIG. 4, the information terminal 102 includes microcomputer 201, and this microcomputer 201 is responsible for the control of each unit. The microcomputer 201 is configured by connecting a ROM (Read Only Memory) 204 that stores fixed information such as a control program, and a RAM (Random Access Memory) 205 that functions as a work area for storing various types of information to be freely rewritable via a bus line 203 to the CPU (Central Processing Unit) 202 that centrally controls each unit.

A touch panel controller 206, display controller 207, storage unit HDD (Hard Disk Drive) 208, interface 209 and communication interface 210 are connected to the microcomputer 201 via bus line 203. The touch panel controller 206 feeds an input signal from touch panel 110 to the microcomputer 201. The display controller 207 drives and controls the display 109 based on the image data. Thus, the display controller 207 displays the image corresponding to the image data on the liquid crystal display 109. Interface 209 is an interface for connecting the scanner 103, printer 106, customer-side display device 107, etc. to the microcomputer 201. As previously mentioned, the interface 209 is configured with USB or other standard interface. Communication interface 210 is an interface that enables communication of data from microcomputer to other machines via LAN.

The HDD 208 stores the OS (Operating System), computer programs, files, and the like. At the time of start-up of the information terminal 102, the OS, programs, necessary files and the like are completely or partially copied to the RAM 205 and accessed by the CPU 202. The CPU 202 carries out processing (for example, the sales registration process and sales counter management process) in accordance with the OS and/or programs.

FIG. 5 is a block diagram showing components of the store computer 105 of this embodiment. As shown in FIG. 5, the store computer 105 includes a microcomputer 301. The microcomputer 301 controls each unit. The microcomputer 301 is configured by connecting the ROM 304 that stores fixed information such as the control program, etc. and the RAM 305 that functions as a work area for storing various types of information to be freely rewritable via a bus line 303 to the CPU 302 that centrally controls each unit.

A display/keyboard controller 306, an HDD 307 that functions as a storage unit, and a communications interface 308 are connected to the microcomputer 301 via the bus line 303. The display/keyboard controller 306 controls and drives the display 116 based on the image data and displays an image on the display 116 in accordance with the image data. Also, the display/keyboard controller 306 feeds the input signal from the keyboard 117 to the microcomputer 301. The communication interface 308 is an interface that enables communication of data from the microcomputer 301 to other machines via LAN.

The HDD 307 stores the OS, programs, data files, and the like. At the time that the store computer 105 starts up, the OS, programs, and necessary files are completely or partially copied to the RAM 305 and are accessed by the CPU 302. The CPU 302 carries out processing in accordance with the OS and/or programs.

The various data files stored by the HDD 307 include a product master table 371, store sales table 372, sales counter video data 373 and analysis data 374. The product master table 371 stores the data related to the products sold in the store. The product master table 371 is data set beforehand by the set-up process of the information terminal 102, and it is referenced at the time of executing the sales registration process by the information terminal 102 functioning as POS terminal. The store sales table 372 includes the data related to the store sales. The sales related data of the store sales table 372 is updated by the execution of the sales registration process by the information terminal 102 functioning as POS terminal. The sales counter video data 373, includes the video data of the sales counter that is filmed and transmitted based on a schedule by the live camera 104 installed on each sales counter. The analysis data 374 includes the analysis process results of the store computer 105.

FIG. 6 is a diagram showing an example of data items included in the product master table 371. As shown in FIG. 6, the product master table 371 includes data items such as a product code, product name, unit price and product classification code. The product code is a specific code assigned to each product in order to identify the various product items sold in the store. Also, the product name, unit price and product classification code are information about the product identified by the same product code. For example, the product classification code is a code showing the product classification for each sales counter. Thus, for a product specified with a product code, it is possible to identify its corresponding sales counter by referring to the product classification code.

FIG. 7 is a diagram showing an example of data items included in the store sales table 372. As shown in FIG. 7, the store sales table 372 includes data items such as a transaction number, transaction type, sales data transmitted from the information terminal 102, and date and time data for each sales registration. At the request of the information terminal 102 or at a fixed time (for example, once a day), the CPU 302 aggregates the sales data registered in the store sales table 372 for each day or time period based on the date and time data. The aggregated sales data is transmitted to a main server device (not shown in figure) installed at a main store or to the information terminal 102 that made the request.

The aggregation of sales data for each day/each time period can also be carried out by the information terminal 102. More specifically, the CPU 302 transmits the sales data registered in the store sales table 372 to the information terminal 102, depending on the request from the information terminal 102. Thus, it becomes possible to aggregate the sales for each day/each time period based on the date and time data item stored in the information terminal 102.

The sales registration process carried out by the information terminal 102 will now be explained. In the sales registration process, the CPU 202 stores the product code input by the scanner 103 into a work area of the RAM 205. Also, the CPU 202 stores the transaction type and unit sales input from the touch panel 110 into the work area of the RAM 205. A regular transaction, discount transaction, card payment, etc. are examples of different types of transactions.

Furthermore, the CPU 202 obtains a selling price, product name, etc. by searching the product master table 371 stored in the store computer 105 based on the information stored in the work area. The CPU 202 creates the sales data based on this product code, unit sales, product name, selling price, etc. Then, the CPU 202 calculates the total amount of sales for each input product, and it repeats this function until the operation input instruction that closes one transaction (for example, by pressing of Total key on touch panel 110) is carried out. When the closing of one transaction is instructed, the CPU 202 transmits the sales data of that transaction to the store computer 105, along with the transaction number for identifying the transaction and the input transaction type. In the store computer 105, the sales data sent by information terminal 102 (i.e., the transaction number, and the transaction type) are registered in the store sales table 372.

The sales counter video data 373 is now explained. An index file, an image file—for instance, video data in MPEG (Moving Picture Experts Group) format taken by each live camera 104, and position data according to a preset camera position are stored according to their date in the sales counter video data 373.

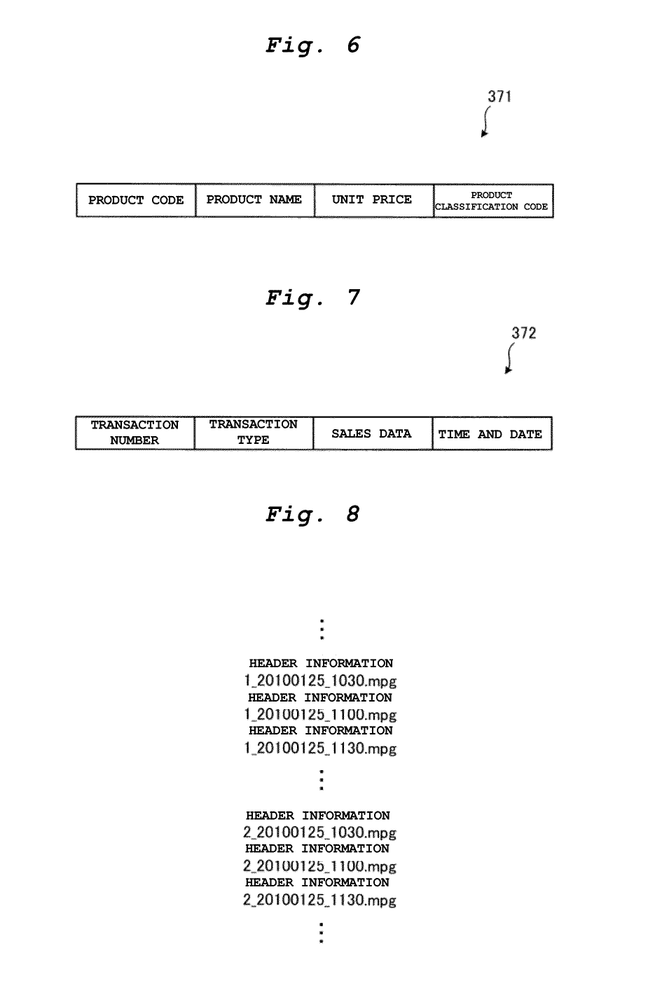

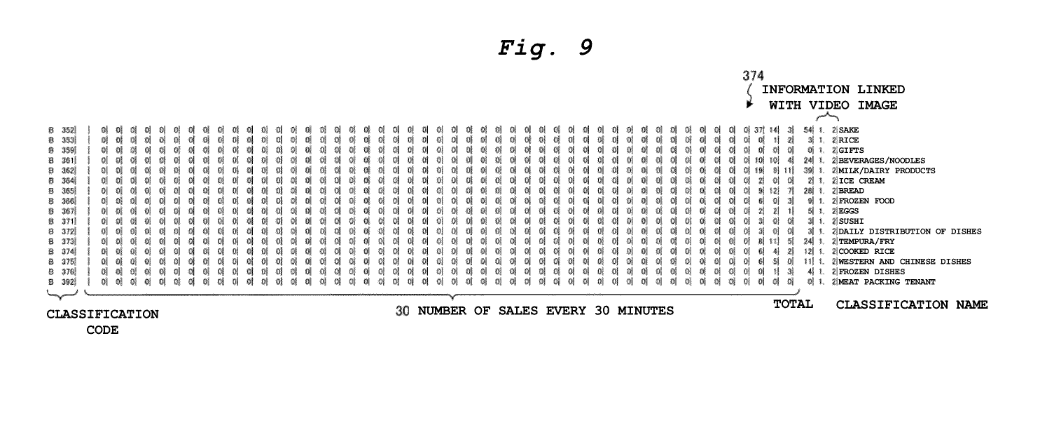

FIG. 8 is a diagram that shows one example of the image file that composes sales counter video data 373. As shown in FIG. 8, the image file is stored in such a form that the header information and the MPEG file follow each other in continuation. Camera position information (which can be used for image synchronization, explained below) and an image acquisition time are included in the header information.

The header information is saved in the index file to speed up processing. Specifically, in the sales counter video data 373, the image file (containing the video data from the live camera 104 installed at each counter) is recorded and stored for each time period.

According to the embodiments, the following file naming protocols are used. The first numeric string is a code that indicates the sales counter. The next numeric string after the first under-score is the date on which picture is taken. The numeric string after the second under-score is the time that the video image was acquired from the live camera 104.

In the example shown in FIG. 8, in case of “1_{—}20100125_{—}1030.mpg”, the first “1” shows the sales counter, such as daily dishes (i.e., prepared food), “20100125” indicates that the picture is taken on Jan. 25, 2010, and “1030” indicates that picture is taken at 10:30. The CPU 302 acquires the video image delivered from each live camera 104 installed at each sales counter, at the end of a fixed time interval (for instance, every 30 minutes). The previously mentioned file name is given and recorded in sales counter video data 373. Therefore, the video image of each time period for each sales counter can be searched for and acquired by referring to the file name of the data file recorded in the sales counter video data 373. In this preferred embodiment, the image of each time period for each sales counter is acquired by referring to the index file in order to speed up the display.

In this preferred embodiment, the video image data for each time period for every counter is obtained and stored as a video file. Furthermore, a static image from any point in time can be acquired by specifying a frame position for a video file corresponding to a desired time period and sales counter.

Next, the analysis data 374 is explained. In the store computer 105, the analysis data 374 is generated based on the sales data recorded in the store sales table 372, which is tabulated by the information terminal 102. An example of the analysis data 374 is shown in FIG. 9. As shown in FIG. 9, the analysis data 374 includes a classification code of major classification and minor classification according to products, a classification name, image synchronization information (i.e., camera position), number of sales over a given period (such as 30 minutes), and total sales.

Furthermore, the analysis process in the store computer 105 can be executed when there is no analysis data 374. However, even if there is analysis data 374, new data such as sales data recorded in the store sale table 372 needs to be acquired.

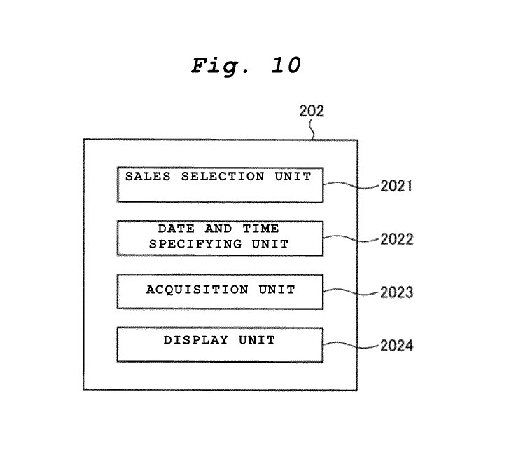

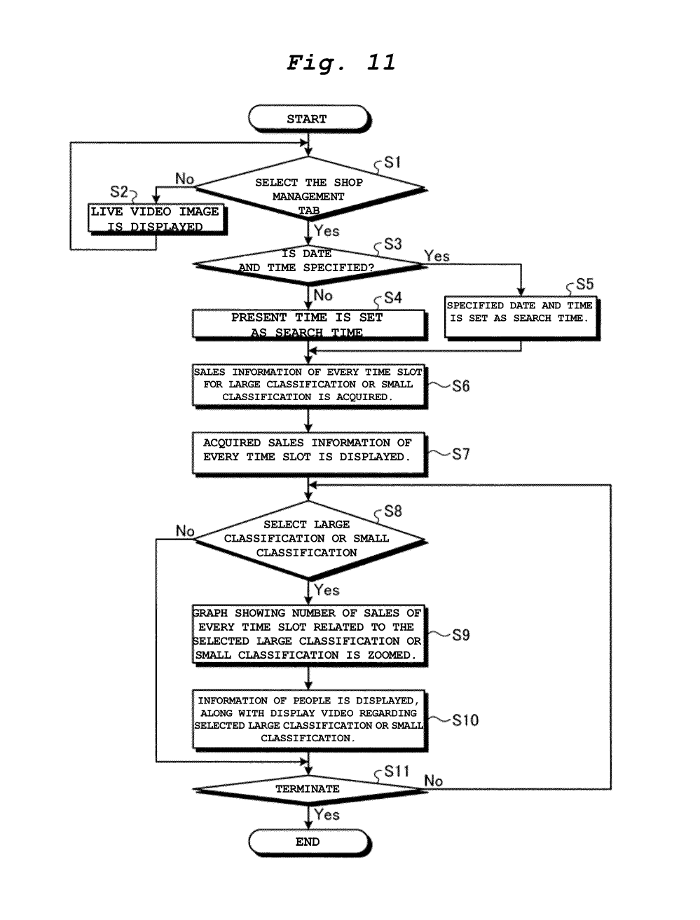

The functional block figure shown in FIG. 10 and the flow chart shown in FIG. 11 refer to an example of the operation of the information terminal 102, which is achieved by the CPU 202 according to the program memorized in HDD 208.

As shown in FIG. 10, by executing the program, the CPU 202 functions as a sales selection unit 2021, a date and time specifying unit 2022, an acquisition unit 2023 and a display unit 2024.

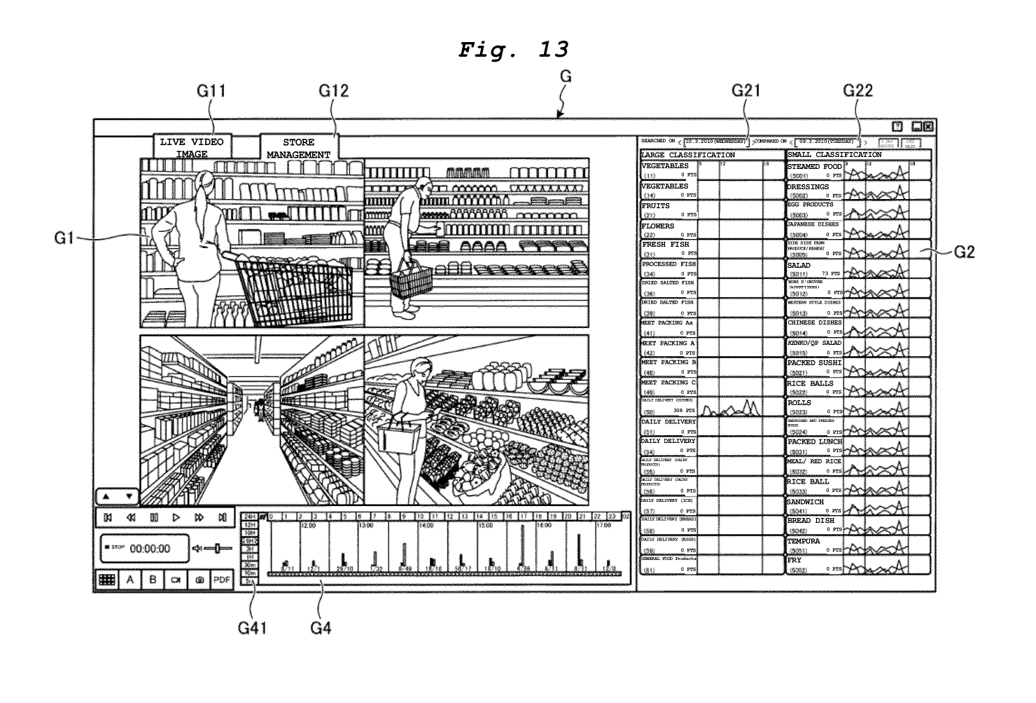

The sales selection unit 2021 selects the fixed sales. Specifically, the sales selection unit 2021 selects the major classification or minor classification on the sales display window G2 based input from, for example, the touch panel 110. The sales selection unit 2021 also selects the sales counter, based on input when the sales display window G2 is displayed (refer to FIG. 13).

The date and time specification unit 2022 specifies the date. Specifically, the date and time specification unit 2022 can specify the date and time based on input from, for example, a numeric button configured on the touch panel 110. The date and time specification unit 2022 can specify the date and time based on a touch operation on a menu (details are described later) listing various time periods. When the date and time are not specified by the date and time specification unit 2022, only the current time is set to be the searching time, which becomes the searching standard. When the date and time are specified, the specified time and the current time are set to be searching time, which becomes the searching standard.

The acquisition unit 2023 calculates the number of people who stop at each of the counters where the product is displayed. The acquisition unit 2023 also calculates the sales of that product. In this preferred embodiment, as one example, the number of sales of product refers to the number of sales according to each classification of product (for instance, minor classification). Moreover, the acquisition unit 2023 calculates the number of people who passed through each of the counters.

The acquisition unit 2023 calculates the number of people who stop at each of the sales counters and the number of people who passed each of the counters by using the video data of live camera 104 that is installed for each counter and takes picture of the counter. The acquisition unit 2023 calculates the number of people who stop at each of the sales counters and the number of people who passed through each of the counters in the unit of counter.

The display unit 2024 displays a graph of data that is specified by the sales counter selection unit 2021 in the time frame selected by the date and time specification unit 2022. Moreover, the display unit 2024 displays the image (dynamic picture image) of at least one date and time that is specified by the date and time specification unit 2022 based on the video data taken by the live camera 104 which corresponds to the sales counter selected by the sales counter selection unit 2021. Moreover, the display unit 2024 displays the number of people who stop at each of counter, calculated by the acquisition unit 2023. The display unit also displays the sales of selected products. The display unit 2024 also displays the number of people who stop at the sales counter. The display unit 2024 also displays the number of people who passed each of the counters, as calculated by the acquisition unit 2023. For example, the display unit 2024 displays a graph of the number of people who stop at the sales counter and the sales of product, as well as the number of people who passed the counter, in the specified time frame.

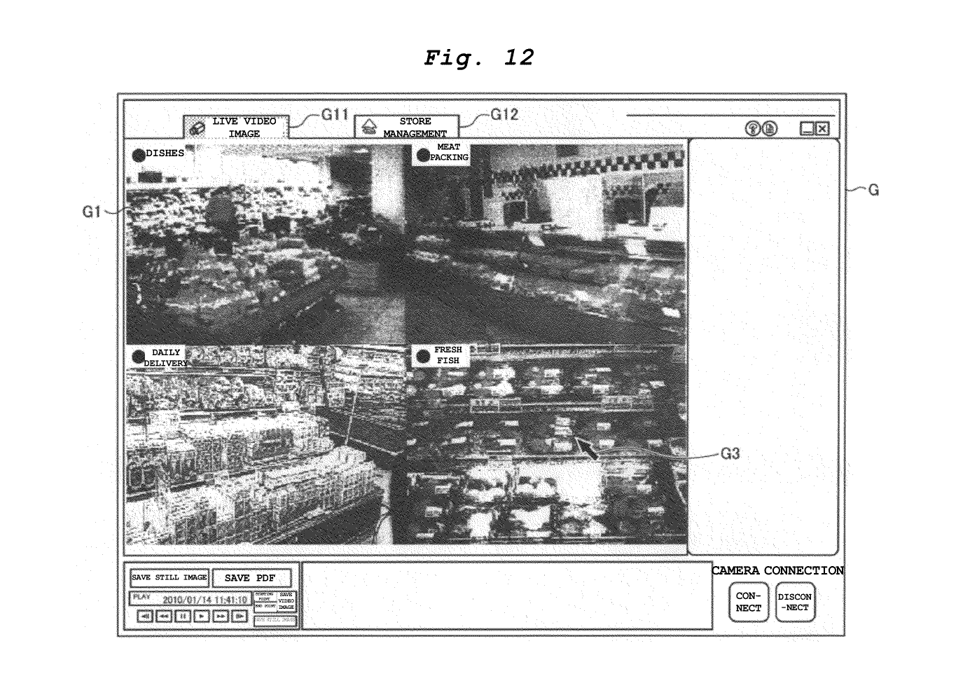

As shown in FIG. 11, when the process is started and when the display screen required for the sales counter management is displayed in display 109, the CPU 202 judges whether the tab of the sales counter management on the display screen (refer to FIG. 12) is selected by the touch panel 110 (S1).

FIG. 12 is a drawing that shows one example of display screen G. The display screen G is a display screen that is displayed in the display 109 in the sales counter management processing and that is required for the sales counter management. As shown in FIG. 12, the information window G1 and cursor G3 are displayed in the display screen G.

As can be seen in FIG. 13, the information window G1 is provided by the tab G11 and tab G12. The information window G1 includes information corresponding to the tab selected with the help of cursor G3. The tab G11 is a tab to display the live video of the sales counter in information window G1. The tab G12 is a tab of the sales counter management for displaying information related to the sales counter management in the information window G1, sales display window G2 and the sales display expansion window G4.

In the example shown in FIG. 12, the tab G11 is selected, and the live video of 4 sales counters (i.e., daily dishes, fresh meat, daily products and fresh fish) where live camera 104 is arranged is displayed in information window G1. The cursor G3 moves on display screen G corresponding to input such as the touch operation of touch panel 110.

Returning to FIG. 11, in S1, (No) when the tab G12 of the sales counter management is not selected with the touch panel 110 (that is, when the tab G11 to display the live video has been selected), the CPU 202 acquires the live video of the sales counter. The live video is delivered by the live camera 104, one of which is installed at each sales counter, and it is displayed in the information window G1 (S2). The processing is returned to S1 after S2. Therefore, the display of a live video is continuous while the tab G11 has been selected.

In S1, (Yes) when the tab G12 of the sales counter management has been selected by the touch panel 110, the CPU 202 judges whether there is specification of the date and time, as discussed above in connection with the date and time specification unit 2022.

As discussed above, when the date and time are not specified (S3: No), the CPU 202 sets only the current time, which becomes the searching standard (S4). Moreover, when the date and time are specified (S3: Yes), the CPU 202 sets the specified date and time to be a searching time, which becomes the searching standard (S5). When only one of the date and time is specified—for example the date is specified but the time is not specified—the specified date and the current time are set as searching time, which becomes the searching standard.

Then, the CPU 202 acquires the sales information (sales data) on every time period related to the major classification or the small classification based on the searching standard (S6). Specifically, the CPU 202 acquires the analysis data 374 from the store computer 105, and the sales data of every time zone related to the major classification or the small classification is extracted from the product classification code included in the analysis data 374.

Furthermore, the CPU 202 displays the sales information of each time zone related to the acquired major classification or minor classification of the display screen G (S7). FIG. 13 shows one of the examples of the display screen G. As shown in FIG. 13, the sales information for each time zone related to the acquired major or minor classification is displayed by the graph (i.e., a bar graph or sequential line graph) on the sales display window G2 of the display screen G. In case of the sales information for each time period related to the major or minor classification displayed on the sales display window G2, the sales information of the specified days is displayed when two dates and times are specified. Sales information of the specified day is displayed when only one date and time are specified. When date and time are not specified, the sales information of that current day only is displayed. In other words, in the graph displaying a specified date and time, sales information from multiple days is displayed in a time series.

When the sales display window G2 is displayed, the CPU 202 determines whether there is selection of the major classification or minor classification in the sales display window G2, based on input such as a touch operation on the touch panel 110 (S8). When it is determined that there is no selection of major classification or minor classification (S8: No), the process is carried out repetitively (looped) until the completion of process (S11: Yes) or until the selection of major classification or minor classification is input.

When it is determined that there is a selection of major classification or minor classification (S8: Yes), the CPU 202 expands the graph (for example, via a bar graph) showing the number of sales per each time zone related to the selected major classification or minor classification. The expanded graph is displayed in the sales display expansion window G4 on display screen G (S9).

Moreover, if the CPU 202 selects the major classification, the minor classification displayed on the sales display window G2 is changed. In other words, each minor classification belonging to the selected sales place (major classification) is expanded, and the sales graph is displayed. Moreover, the CPU 202 can change the time frame of the sales display expansion window G4 according to scale G41. For instance, the time frame of the scale can be set to 5 minutes, 10 minutes, 30 minutes, 1 hour, 3 hours, 6 hours, 10 hours, 12 hours, or 24 hours. If the time frame of the scale is shortened, it is possible to refer to the in-depth data. If the time frame of the scale is broadened, comparison of data is possible. For example, data gathered at morning time, data at collected noon, and data gathered at night time can be compared.

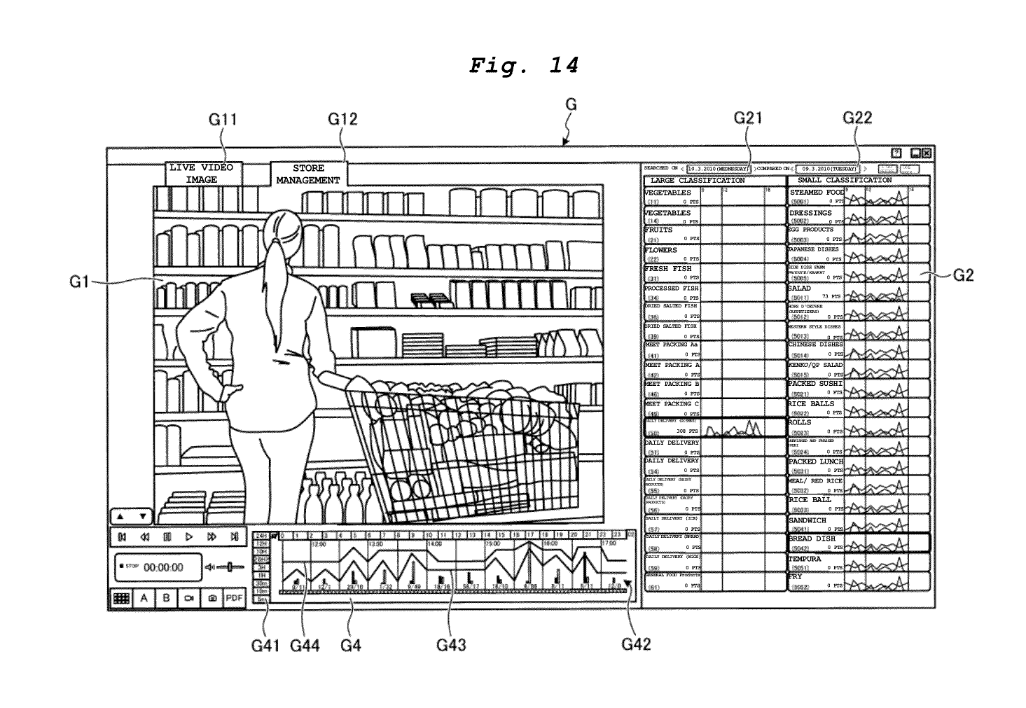

In addition, based on the selected search time, the CPU 202 displays the video image corresponding to the major classification or minor classification selected in S8 per each time period on the information window G1 (S10). FIG. 14 shows an example of the display screen G. The CPU 202 acquires the sales video data from the store computer 105. By referring to the index file recorded in the sales video data 373, the video image data of the selected time frame is extracted from the image file related to the selected major classification and minor classification based on the search time. Furthermore, as shown in FIG. 14, the extracted video image data is displayed on the information window G1 of the display screen G. More precisely, the video image from the live camera at the sales counter corresponding to the selected major classification or minor classification is acquired from the analysis data 374. Based on the selected sales counter (i.e., specified camera position) and set search time, an index file is retrieved, and the MPEG file is extracted only for the prescribed time period.

In the example shown in FIG. 14, on the information window G1, a video image of the “2010/01/25, 10:30,” which is set search time (G21), is reproduced. Each video image shows the video of sales transacted every 30 minutes. Therefore, the user can confirm the status of a display rack associated with the sales of each 30 minutes from “2010/01/25, 10:30” to “2010/01/25 18:00,” as displayed in that video. The display state shown in FIG. 14 is one of the examples. The frame-position of the video image to be displayed can be changed accordingly.

Furthermore, the CPU 202 displays the information of the number of people by acquiring the information associated with the counter-specific number of people who stop at the counter of the store as ‘number of people stopped’ and the number of people passing by as ‘number of people who passed by’ by using the sales counter video data 373 acquired from the store computer 105. As an example, the CPU 202 uses the sales counter video data 373 and a comparative video data (background data) to calculate the ‘number of people stopped’ and the ‘number of people who passed by’. The comparative video data refers to data captured by the live camera 104 when there are no people at the sales counter. While taking this comparative video image, the products may or may not be displayed at the counter. The CPU 202 calculates the difference (by comparing) between sales counter video data 373 and comparative video data. If there are movable objects of size (area) more than that regulated by the sales counter video data 373, the relevant movable object is determined to be a person.

When the person passes the sales counter, he or she is counted in the tabulation of the ‘number of people who passed’. Furthermore, persons passing through a specific location in the store can be counted as people passing in the store. Moreover, the CPU 202 calculates the difference (by comparing) between the sales counter video data 373 and the comparative video data. If there are people located in the same location for a period of time greater than that stipulated in the sales counter video data 373, the relevant people are determined to be ‘stopped’ (halted) and counted as people stopped at the sales counter. In this way, the CPU 202 counts the number of people passing and the number of people stopping at each sales counter for every time frame related to the major classification or minor classification selected by S8.

In the example shown in FIG. 14, for the sales counter including the product of daily dishes (i.e., prepared food) as a minor classification, the number of sales, the number of stopped people and the number of people passing through are graphically displayed in sales display wide window G4, as an example. The number of sales is displayed by using a bar graph G42. The number of people stopped is displayed by using a line graph G43. The number of people who passed by is displayed by using a line graph G44. In other words, the number of sales of one product (minor classification) of one sales counter, the number of people stopped, and the number of people who passed by that sales counter are displayed in a unified graph. Furthermore, the number of sales, the number of people stopped, and the number of people who passed by are not restricted to being displayed in a graph form; they can also be displayed in a chart.

As previously mentioned, in the display screen G, the image of each time period of the selected sales counter is displayed in the information window G1, and the sales information of each time zone of the selected sales counter is displayed in sales display wide window G4. Therefore, from the image of the sales counter of each time zone, the user can confirm not only the sales information of each time period of the sales counter, but also the current status of sales counter, such as the status of the display shelf in the sales counter. Sales information from each time zone displayed in the sales display wide window G4 already exists as settled data.

The video image displayed in information window G1 is a picture of the sales counter of each time period, and it shows the present status of the sales counter. Moreover, the information window G1 and the sales display wide window G4 are displayed in the identical display screen G and, thus, can be easily compared. Therefore, by comparing the sales information from each time zone displayed in sales display wide window G4 and the picture of the sales counter from each time period displayed in information window G1, the user can intuitively understand the flow of customers wandering in the store. In this way, by understanding the flow of customers wandering in the store, the user can accurately predict the sale of product and can carry out sales management, which prevents the loss of sales opportunities due to no more goods on the display shelf and also reduces the loss of goods by discarding the unsold goods.

Moreover, the sales information of the present day and the sales information of the specific day are displayed in chronological order in the graph, which specifies date and time. By doing so, the activation of a sales counter in a popular time period (i.e., a high number of people walking by the sales counter) and near a popular range of goods can be planned by comparing the sales of the counter with the sales that took place on the same day of the previous week.

Next, the CPU 202 determines whether there is an input (such as from the touch panel 110) for completing the process and, thus determines whether the process is completed (S11). When there is an operation input for completing the process by using the touch panel 110 (S11: Yes), the process is completed as it is. When there is no operation input for completing the process by using the touch panel 110 (S11: No), the selection process of major classification or minor classification is continued by returning back to S8.

As previously explained, in this embodiment, the display means 2024 displays the number of people stopped at the sales counter where goods are displayed with the number of sales of goods. Therefore, the information terminal 102 can provide the number of people stopped at each sales counter in addition to the number of sales of goods to the user. The user can analyze the sales condition of goods by using the number of sales of goods and the number of people stopped at each sales counter.

For example, if the amount of sales of a product is comparatively less, regardless of the number of people stopped being comparatively more, the user can analyze that the customer is interested in the product but that, as its cost is high, the customer has not purchased it. In this way, according to this embodiment, the information that can be used to analyze the reason that a product is not selling can be provided.

Moreover, in this embodiment, the acquisition unit 2023 acquires the number of sales for each class of product as number of sales of the product. Therefore, the number of sales for each class of product and the number of people stopped at each sales counter can be displayed.

Moreover, in this embodiment, the display unit 2024 displays the number of people passing by the sales counter, along with the number of people stopped at sales counter and the number of sales of a product. Therefore, the user can understand the number of people passing by the sales counter.

Furthermore, the program executed by the information terminal 102 of this embodiment is stored in the HDD 208 or ROM 204. The program executed by the information terminal 102 of this embodiment can also be included on a readable recording medium by using installable or executable files in a CD-ROM, flexible disk (FD), CD-R, DVD (Digital Versatile Disk), or in a computer.

In addition, the program executed by the information terminal 102 of this embodiment is stored in the computer connected to a network such as internet, and it can also be constructed so that it is provided by downloading it from the network. Moreover, the program executed by the information terminal 102 of this embodiment can be provided or distributed by using a network such as internet.

In addition, the process of information terminal 102 established in the register or store office is illustrated in this embodiment, but it is needless to say that the process conducted by the information terminal 102 can be executed by store computer 105 or upper level server device installed in the store.

Furthermore, in this embodiment, an illustration is provided to explain that the acquisition unit 2023 calculates the number of sales of each classification of product and the display unit 2024 displays the number of sales of each classification of that product. The acquisition unit 2023 and display unit 2024 are not restricted to only these functions.

For instance, the acquisition unit 2023 can calculate the number of people stopped in front of the single item of each product (number of people stopped) and acquire the number of sales of each unit of that product. The display unit 2024 can then display the number of sales of the product and the number of people stopped in front of the product. In this embodiment, the display position on the display shelf of the sales counter of each unit of the product is recorded in advance by the live camera 104. This video image data containing the display position of the product is recorded in the product master table 371, which is indexed according to the product code. Then, the acquisition unit 2023 obtains the position where the customer had stopped and also the time from the video image data of live camera 104 and records it in the memory part such as in the RAM. Furthermore, the product displayed in the display shelf corresponding to the position where the customer had stopped is extracted from the product master table 371. In this way, the number of people stopped in front of that single product can be calculated for each product.

Moreover, in this embodiment, information about the number of people stopped at the counter and the number of people who passed by the counter is obtained by the using the live camera 104. However, it is not restricted to only this live camera. For instance, an infrared sensor can be installed at the sales place instead of the live camera 104. The infrared sensor can capture and transmit information about number of peoples stopped at the counter and number of peoples passing through the counter.

While certain embodiments have been described, these embodiments have been presented by way of example only and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information terminal comprising:
an acquisition unit configured to calculate a number of people who stop at a counter where a product is displayed over a time period, and acquire sales data of the product over the time period; and
a display unit configured to display the number of people who stop at the counter over the time period and the sales data of the product over the time period.

2. The information terminal according to claim 1, wherein
the acquisition unit is configured to calculate the number of people who stop at the counter by using image data from an imaging device that takes an image of the counter.

3. The information terminal according to claim 2, wherein
the display unit is further configured to display the number of people who stop at each counter over the time period, the sales data of the product over the time period, and at least a portion of the image data from the imaging device over the time period.

4. The information terminal according to claim 1, wherein
the sales data includes sales information according to a classification of the product.

5. The information terminal according to claim 1, wherein
the display unit is configured to display the number of people who stop at each counter over the time period and the sales data of the product over the time period in a unified graph.

6. The information terminal according to claim 1, wherein
the acquisition unit is further configured to calculate a number of people who passed by the counter over the time period; and
the display unit is further configured to display the number of people who passed by the counter over the time period.

7. The information terminal according to claim 6, wherein
the display unit is configured to display the number of people who stop at each counter over the time period, the sales data of the product over the time period, and the number of people who passed by the counter over the time period in a unified graph.

8. A method of analyzing sales, the method comprising
calculating a number of people who stop at a counter where a product is displayed over a time period;
acquiring sales data of the product over the time period; and
displaying the number of people who stop at the counter over the time period and the sales data of the product over the time period.

9. The method of analyzing sales according to claim 8, wherein the step of calculating a number of people who stop at a counter where a product is displayed over a time period comprises using image data from an imaging device that takes an image of the counter.

10. The method of analyzing sale data according to claim 9, further comprising displaying a portion of the image data from the imaging device over the time period.

11. The method of analyzing sales according to claim 8, wherein the sales data includes sales information according to a classification of the product.

12. The method of analyzing sale data according to claim 8, wherein the displaying step comprises displaying the number of people who stop at each counter over the time period and the sales data of the product over the time period in a unified graph.

13. The method of analyzing sale data according to claim 8, further comprising:
calculating a number of passing people who passed by the counter over the time period; and
displaying the number of people who passed by the counter over the time period.

14. The method of analyzing sale data according to claim 13, wherein the number of people who stop at each counter over the time period, the sales data of the product over the time period, and the number of people who passed by the counter over the time period are displayed in a unified graph.

15. A non-transitory computer-readable storage medium that stores a computer program that causes a computer to perform the steps of:
calculating a number of people who stop at a counter where a product is displayed over a time period;
acquiring sales data of the product over the time period; and
displaying the number of people who stop at the counter over the time period and the sales data of the product over the time period.

16. The non-transitory computer-readable storage medium according to claim 15, wherein the stored computer program further causes a computer to perform the step of calculating the number of people who stop at the counter by using image data from an imaging device that takes an image of the counter.

17. The non-transitory computer-readable storage medium according to claim 16, wherein the stored computer program further causes a computer to perform the step of displaying the number of people who stop at each counter over the time period, the sales data of the product over the time period, and at least a portion of the image data from the imaging device over the time period.

18. The non-transitory computer-readable storage medium according to claim 15, wherein the stored computer program further causes a computer to perform the step of displaying the number of people who stop at each counter over the time period and the sales data of the product over the time period in a unified graph

19. The non-transitory computer-readable storage medium according to claim 15, wherein the stored computer program further causes a computer to perform the steps of:
calculating a number of people who passed by the counter; and
displaying the number of people who passed by the counter over the time period.

20. The non-transitory computer-readable storage medium according to claim 19, wherein the stored computer program further causes a computer to perform the step of displaying the number of people who stop at each counter over the time period, the sales data of the product over the time period, and the number of people who passed by the counter over the time period in a unified graph.
